(19) United States
(12) Patent Application Publication
(10) Pub. No.: US 2022/0312696 A1
(43) Pub. Date: Oct. 6, 2022

(54) Adaptable Integrated Water Delivery for Drip Irrigation Systems

(71) Applicant: Abhinav Vanteru Reddy, Riverside, CA (US)

(72) Inventor: Abhinav Vanteru Reddy, Riverside, CA (US)

(21) Appl. No.: 17/837,040

(22) Filed: Jun. 10, 2022

(51) Int. Cl. A01G 25/06

(52) U.S. Cl. CPC A01G 25/06

(57) ABSTRACT

An underground storage system for drip irrigation products is described herein. Drip irrigation systems may include an outlet connected to a tube filled with continuously flowing water, in which the water pressure must be high enough to force droplets out of the outlet and onto the soil. This is controlled by an irrigation control valve. The droplets then deposit on the surface of the soil surrounding the plant. Herein lays the problem, as excessive heat may cause the water to evaporate, ceasing any function that the drip irrigation provides. Utilizing a water tight, underground storage method, the invention would deliver water directly to the roots. This would help with the problem of evaporation and decrease water irrigation needs.

### BACKGROUND

The present invention relates to a direct delivery system for water to plant roots, adaptable to most drip irrigation systems. Throughout the United States, drip irrigation systems allow for immense water saving irrigation to take place. Drip irrigation systems, consisting of an insert, are attached to a pipe carrying water. As the water pressure builds up in the pipe, it pushes water out, droplet by droplet. This allows the water to be directly absorbed into the roots of the plants, preventing water runoff and therefore soil erosion. Drip irrigation also increases the times at which the plant is watered, and decreases the risk of plants developing diseases due to excess moisture. However, a common problem that is occurring with the increase in temperatures across the US, is the evaporation of the products of the drip systems. Before the water has time to absorb in the plant, the water evaporates. This devoids the plant of any benefit of the drip irrigation, while also increasing the amount of water used to obtain a similar result. Thus, there are shortcomings in existing current drip irrigation systems

### DETAILED DESCRIPTION

The invention submitted herein is to describe a direct delivery of water to the roots of a plant, retrofitted to existing drip irrigation systems. The description is to be used to provide useful information on how said invention may be used, and how it solves a problem. Throughout the United State drip irrigation is a common irrigation system used in all facets of agriculture. The basis of the system is that instead of a spread of water given by conventional sprinklers, drip irrigation delivers the water to the ground directly above the roots of the plants. The system through which it achieves this is simple. Connected to a source of water, a pipe carrying the water is routed to all of the plants. This is called poly-tubing. At every point that the user wishes to place a drip point, an emitter is placed. This emitter is an outlet through which water is pushed out. When the system is activated, a constant state of pressure is created throughout. This is done by an attachment called the pressure regulator. Onto the emitter. The water can come out in a variety of forms, including but not limited to mist, droplets, or steady streams. The present invention includes a locking system which is connected to the emitters. The cap of the storage container is fashioned in such a way that the emitter inserts to the inside of the cap. The part of the emitter may then be inserted into the tubing which holds the running water, extending through the cap and into the tubing. Thus as the pressure increases the more water is pushed into the delivery system, which then transplants the water directly to the roots. This solves multiple problems. First, due to the increase in temperature across the world, drip irrigation systems are starting to waste more water. The drips of water evaporate before the roots can fully absorb them. By placing the water into a storage container, which then delivers the water to the roots, as seen in FIG. 4. In addition, if added nutrients are present, this method would allow the nutrients to seep directly into the ground from around the invention rather than be transmitted through multiple layers of dirt. The process at which the invention is created is not a complex process. Most emitters sold in the United States tend to have a top barb part, followed by a recessed part. A barb part is shown in FIG. 1, by the arrow-like structure. By having a whole in the cap of the delivery and storage container, the emitter may be inserted into the cap. From there, the emitter is plugged into the poly tubing. The delivery storage container, acting as the male head of screw, is then screwed onto the female adapter, or the cap. This then may be inserted into the ground.

### SUMMARY

The present invention is an outdoor garbage container designed to accumulate water from a drip irrigation system underground. The present invention includes a cap and a storage container. The emitter's, an apparatus used in drip irrigation systems to let water flow out, barb is placed in the inside of the cap provided. The barb is then inserted into the tube delivering the water. A storage container provided would then be connected to the cap. It would then be placed underground. This would allow the water to go directly to the roots. Furthermore it halts the process of evaporation in an increasingly warm world.

### PATENT DRAWING DESCRIPTION

FIG. 1. Represents an augmented front side perspective view of the emitter inserted into the cap

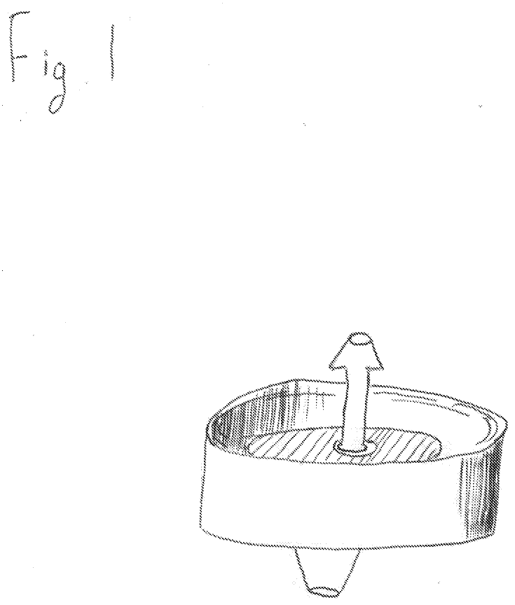

FIG. 2. Represents a frontside orthogonal view of the cap, delivery container, and the emitter

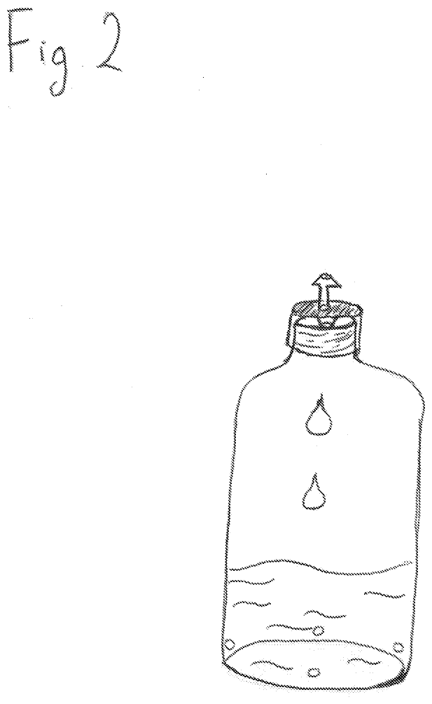

FIG. 3. Represents an exploded view of the water delivery system, cap, emitter, and water tubing

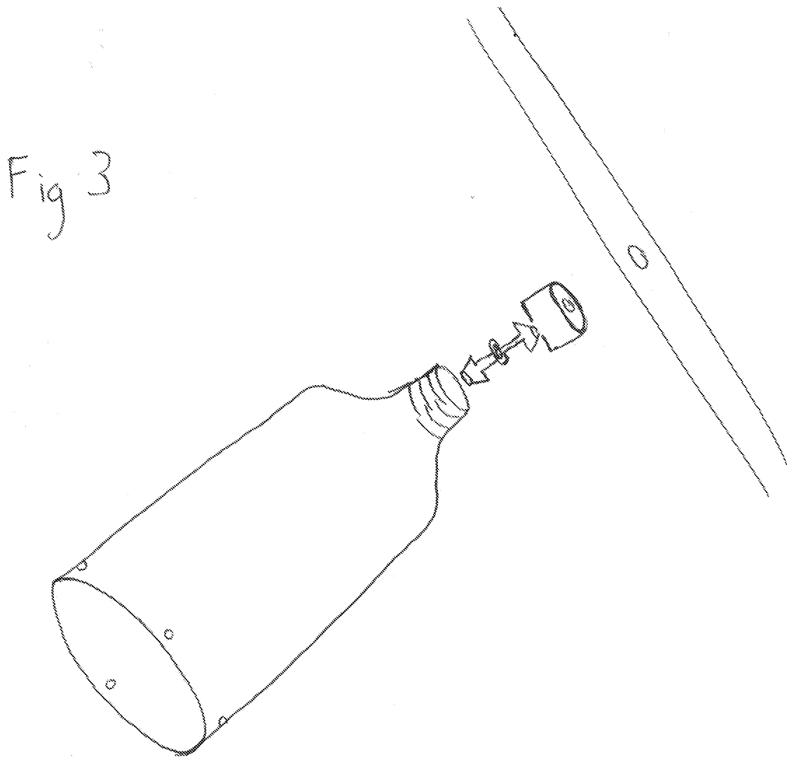

FIG. 4. A Cross sectional view of an example in which the entire apparatus is situated near a plant and its roots.

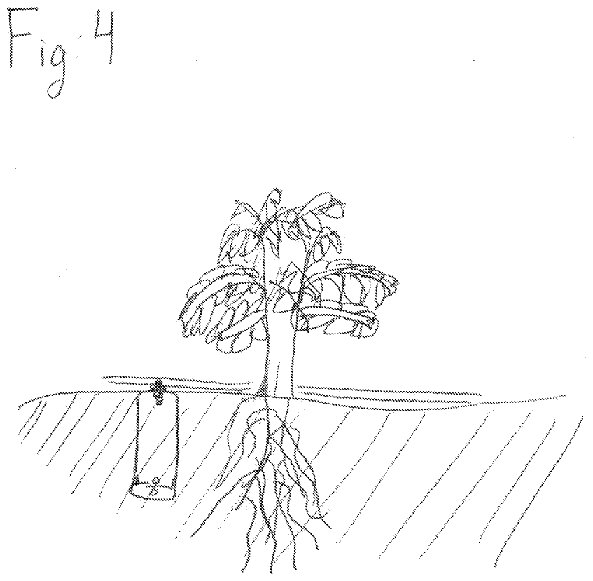

1. A root focused water delivery system consisting of
1. An emitter, an outlet for water which is positioned beneath the cap, and for which the water will then be deposited in the storage/delivery container
2. A storage/delivery container which may have multiple or a single hole at the bottom to deliver the water
3. A cap positioned between the emitter and the poly-tubing to allow for attachment to the storage container
4. The apparatus as a whole, where all the parts are combined, and act as an apparatus
